(19) United States
(12) Patent Application Publication
(10) Pub. No.: US 2022/0281781 A1
(43) Pub. Date: Sep. 8, 2022

(54) BINDERS FOR HYDROSCOPIC SUBSTRATES

(71) Applicant: ArrMaz Products Inc., Mulberry, FL (US)

(72) Inventors: Jessica Quinn, Lakeland, FL (US); Lucas Moore, Dover, FL (US); Mark Ogzewalla, Winter Haven, FL (US)

(73) Assignee: ArrMaz Products Inc., Mulberry, FL (US)

(21) Appl. No.: 17/685,012

(22) Filed: Mar. 2, 2022

Related U.S. Application Data
(60) Provisional application No. 63/156,025, filed on Mar. 3, 2021.

(51) Int. Cl. C05G 5/40; C05G 5/12; C05D 1/00

(52) U.S. Cl. CPC C05G 5/40; C05G 5/12; C05D 1/005

(57) ABSTRACT

A binder for hydroscopic substrates that is organic and thus, when used on fertilizer approved for organic farming, allows the fertilizer to maintain its status while improving the fertilizer's sensitivity to humidity. The binder may be Greek hay, also known as fenugreek gum, and may be applied to a fertilizer substrate.

### CROSS REFERENCE

This application is based on and claims priority to U.S. Provisional Patent Application No. 63/156,025 filed Mar. 3, 2021.

### BACKGROUND OF THE INVENTION

### Field of the Invention

This invention relates generally to fertilizer binders or granulation aid, and more particularly, but not by way of limitation, to a binder that is approved for organic farming and that aids in maintaining granule integrity when exposed to relative humidity and temperature.

### Description of the Related Art

Plants require a wide range of nutrients for optimal crop growth and fruit production. Nutrients come from the air or through adsorption through the root. Continuously farmed soils become depleted of essential nutrients. To maintain soil fertility and maximize crop production, nutrients must be added by the way of fertilizers. Solid fertilizers are typically compacted, prilled, or granulated to produce substrate granules. Binders are applied to aid in building granules to a specific size and strength and with the desired concentration of components. Treating the surface of the granules with coatings can aid in reducing moisture and caking tendencies, but some binders can work adversely in this respect. They can actually cause increased moisture absorption, thus making the granules weak and mushy.

Synthetic, petroleum based, chemically modified, or chemically extracted materials are not allowed under organic farming principals and, as such, many common fertilizers do not qualify for use. The fertilizers that are allowed in organic farming are thus unique and any additive applied to them must retain that status.

It has long been known that materials like corn starch or lignosulfonates can be applied as binders. They are even used in other industries for mineral binding. However, when they are applied as binders in the fertilizer industry, the granules become more sensitive to moisture absorption via exposure to relative humidity and temperature. This will start to negatively interact with the moisture and yield weak pellets or granules.

Based on the foregoing, it is desirable to provide a binder technology that provides improved granule crush strength over the incumbent, both before and after exposure to humidity and temperature.

It is further desirable for the binder technology to provide ease in agglomeration of raw materials; optimized granule, pellet, or prill characteristics or shape; suitability for bulk blending; ease of application with uniform distribution and targeted application of fertilizer; and water solubility.

It is further desirable for the binder technology to fit the requirements for organic farming standards.

### SUMMARY OF THE INVENTION

In general, in a first aspect, the invention relates to a binder for hydroscopic substrates, the binder comprising Greek hay, locust bean gum, carob gum, tragacanth gum, gum ghatti, mucilage gums, guar gum, any other polysaccharides produced from plants, dextran, welan gum, gellan gum, diutan gum, pulluan, pectins, chitin, or cellulose.

In a second aspect, the invention relates to a fertilizer comprising a fertilizer substrate and a binder, where the binder is Greek hay. The Greek hay may comprise at least 0.1% of the fertilizer, but can be as high as 10%. In particular, the Greek hay may comprise at least 0.375% of the fertilizer. The fertilizer may not contain binders other than Greek hay. Alternately, the fertilizer may contain additional binders. The fertilizer substrate may be approved for organic farming.

In a third aspect, the invention relates to a method of producing organic fertilizer, the method comprising: applying a binder solution comprising at least 3% Greek hay to a fertilizer substrate to produce a slurry and drying the slurry to produce fertilizer pellets. The balance of the binder solution may be water. As such, the binder solution may contain only Greek hay and water. The binder solution may be applied at a rate of 12.5% of the slurry. The fertilizer substrate may be approved for organic farming.

In a fourth aspect, the invention relates to a method of producing organic fertilizer, the method comprising: applying powdered Greek hay to a fertilizer substrate at a rate of 0.1 to 10% of the fertilizer substrate; mixing the powdered Greed hay and fertilizer substrate to produce a solid mixture of binder/fertilizer; and spraying water on the solid mixture of binder/fertilizer to produce fertilizer granules.

### BRIEF DESCRIPTION OF THE DRAWINGS

FIG. 1 is a chart showing the sensitivity of granules to moisture absorption, as a consequence of the binding technology;

FIG. 2 is a chart showing trial information;

FIG. 3 is a chart showing the impact of binders on granule integrity initially and after having been aged at a constant temperature of 30° C. and 65% relative humidity for up to six hours;

FIG. 4 is a chart showing the impact of binders on caking reduction;

FIG. 5 is a chart showing the impact of binders on initial dust levels; and

FIG. 6 is a chart showing the impact of binders on reducing the moisture absorption;

Other advantages and features will be apparent from the following description and from the claims.

### DETAILED DESCRIPTION OF THE INVENTION

The devices and methods discussed herein are merely illustrative of specific manners in which to make and use this invention and are not to be interpreted as limiting in scope.

While the devices and methods have been described with a certain degree of particularity, it is to be noted that many modifications may be made in the details of the construction and the arrangement of the devices and components without departing from the spirit and scope of this disclosure. It is understood that the devices and methods are not limited to the embodiments set forth herein for purposes of exemplification.

In general, in a first aspect, the invention relates to a binder technology that provides improved granule crust strength over incumbent, namely corn starch, both before and after exposure to humidity and temperature. The binder technology may fit the requirements for organic farming standards.

In particular, the binder may comprise Greek hay, also known as fenugreek gum. Additionally or alternately, the binder may comprise locust bean gum, carob gum, tragacanth gum, gum ghatti, mucilage gums, guar gum, or any other polysaccharides produced from plants. Other gums, which may include dextran, welan gum, gellan gum, diutan gum, pulluan, etc., may be used as substitutes. Other polysaccharides, such as pectins, chitin, cellulose, etc., may likewise be used as substitutes. There are other gums that would fall within the same performance standards, but may not be classified as organic. The binder may be applied as a solid, dry material at a dosage as low as 0.25% to 5%, or any other desired concentration of binder. The binder may be blended with the fertilizer substrate, which may be mixed. While mixing, water may be sprayed on the surface at a controlled rate to yield the optimal granule size. Alternately, the binder may be applied in a binder solution comprising water and binder. The binder solution may comprise 3% binder, 6% binder, 9% binder, or any other desired concentration of binder. The binder solution may be applied to the fertilizer substrate at a rate of 12.5%, or any other desired rate. Thus, for example, when the binder solution comprises 3% binder and 97% water and is applied at a rate of 12.5%, the total binder content of the resultant slurry may be 0.375%.

Fertilizer or other mineral based granules may be, but are not limited to, muriate of potash, sulfate of potash, polyhalite, leonite, urea, ammonium sulfate, ammonium nitrate, any NPK granular or blended substrate, lime, struvite, any other phosphate, nitrogen, potassium-based substrate, biosolids, calcium and magnesium carbonate, or micronutrients such as minerals consisting of Zn, B, Fe, Mn, Cu, and others. The fertilizer may be organic fertilizer or industrial grade fertilizer.

Applying an effective binder that is approved for organic farming to fertilizer that is allowed under organic farming principals may allow the fertilizer to maintain its unique status, while improving the granules' sensitivity to humidity, which may otherwise weaken the granules.

The binder may also be applied to more traditional substrates, which would not qualify under organic farmer's principals.

### EXAMPLE 1

A potash-containing substrate was received as ground material. A binder solution was added as a total of 12.5% total binder solution. The binder solution was made by changing the concentration of binder in water. Thus, for example, with 3% binder in the 12.5% total solution, only 0.375% of the total slurry was actual binder, with the rest of the solution being water. The following binder solutions were tested: 100% water; 3% cornstarch, 97% water; 3% Greek hay, 97% water; 6% Greek Hay, 94% water; and 9% Greek hay, 91% water.

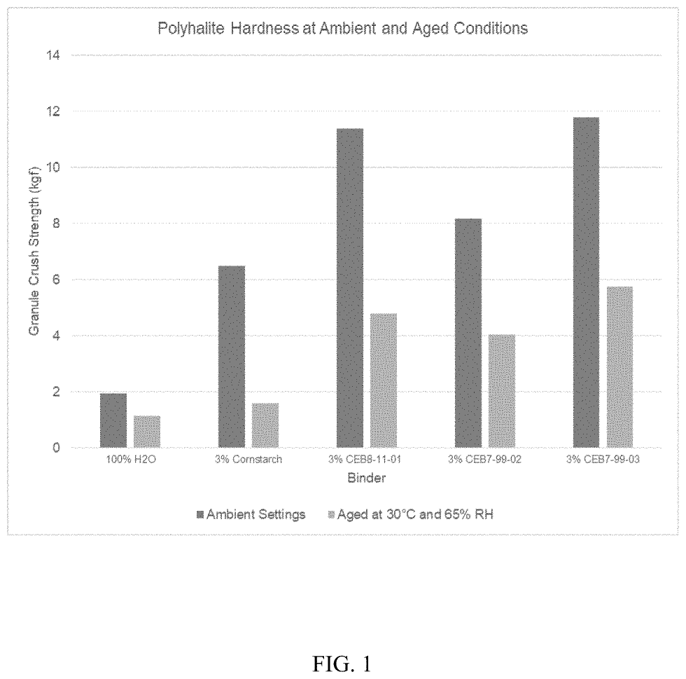

After adding the binder solution, the fertilizer pellets were then dried and measured for granule integrity by measuring the granule crush strength before and after exposing the pellets to humidity and temperature. Exposure to 65% relative humidity at 30 deg C yielded a reduction in the granules bound with cornstarch to a point that was only slightly better than no binder at all. Using 3% Greek hay, on the other hand, produced a granule integrity of 4 kg of force to crush the granule. Even freshly made granules were stronger than those produced from corn starch. FIG. 1 shows the sensitivity of the granules to moisture absorption, as consequence of the binding technology.

### EXAMPLE 2

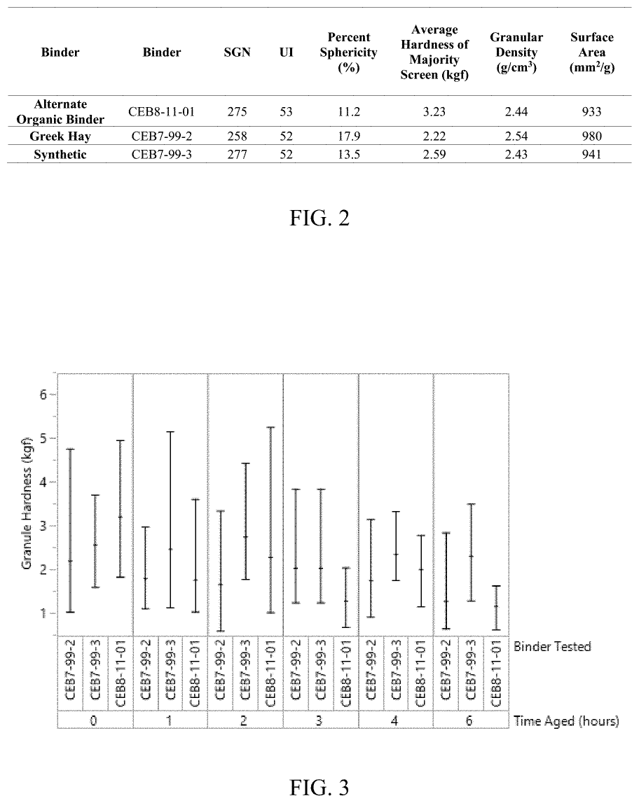

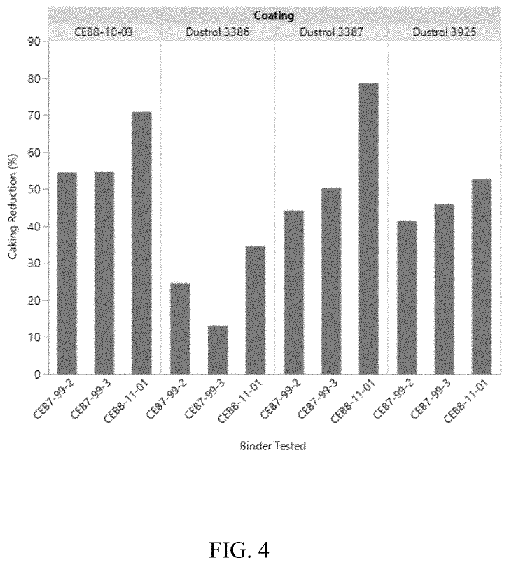

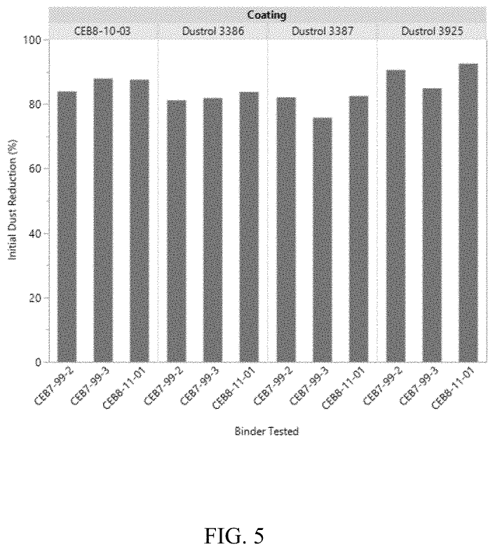

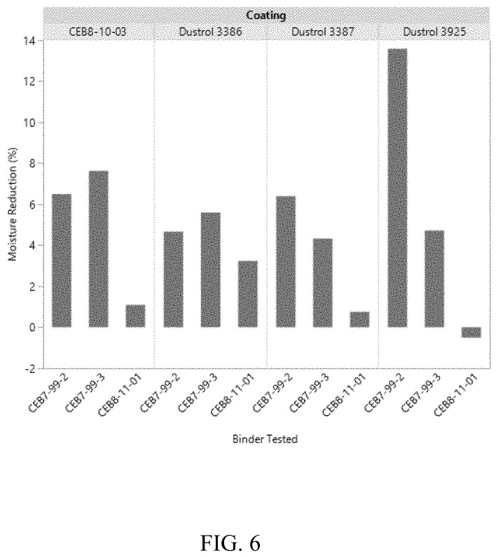

A potash-containing substrate was received as ground material. A dry binder is added at a concentration of 1%. Granulation occurred in a granulation drum where water is sprayed in a controlled manor while the drum is turning. When the granules meet their desired granule size, the granules are then dried. FIG. 2 shows the binder efficiency, which is calculated by its ability to achieve greater than 2 mm particle size.

Whereas, the devices and methods have been described in relation to the drawings and claims, it should be understood that other and further modifications, apart from those shown or suggested herein, may be made within the spirit and scope of this invention.

What is claimed is:

1. A binder for hydroscopic substrates, the binder comprising:
Greek hay, locust bean gum, carob gum, tragacanth gum, gum ghatti, mucilage gums, guar gum, any other polysaccharides produced from plants, dextran, welan gum, gellan gum, diutan gum, pulluan, pectins, chitin, or cellulose.

2. A fertilizer comprising:
a fertilizer substrate; and
a binder, where the binder is Greek hay.

3. The fertilizer of claim 2 where the Greek hay comprises at least 0.1% of the fertilizer.

4. The fertilizer of claim 2 where the fertilizer does not contain binders other than Greek hay.

5. The fertilizer of claim 2 where the fertilizer substrate is approved for organic farming.

6. A method of producing organic fertilizer, the method comprising:
applying powdered Greek hay to a fertilizer substrate at a rate of 0.1 to 10% of the fertilizer substrate;
mixing the powdered Greek hay and fertilizer substrate to produce a solid mixture of binder/fertilizer; and
spraying water on the solid mixture of binder/fertilizer to produce fertilizer granules.

7. A method of producing organic fertilizer, the method comprising:
applying a binder solution to a fertilizer substrate to produce a slurry; and
drying the slurry to produce fertilizer pellets,
where the binder solution comprises at least 3% Greek hay.

8. The method of claim 7 where the balance of the binder solution is water.

9. The method of claim 7 where the binder solution contains only Greek hay and water.

10. The method of claim 7 where the binder solution is applied at a rate of 12.5% of the slurry.

11. The method of claim 7 where the fertilizer substrate is approved for organic farming.
